(19) United States
(12) Patent Application Publication
(10) Pub. No.: US 2006/0240213 A1
(43) Pub. Date: Oct. 26, 2006

(54) Storage medium for the optical storage and retrieval of information

(75) Inventors: Christopher Busch, Eindhoven (NL); Alexander Marc Van Der Lee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,694

(22) PCT Filed: Nov. 20, 2003
(86) PCT No.: PCT/IB03/05445

§ 371 Date: Jun. 16, 2005

(30) Foreign Application Priority Data
Dec. 18, 2002 (NL) 1022203

(51) Int. Cl. B32B 3/02

(52) U.S. Cl. 428/64.4

(57) ABSTRACT

The invention relates to a storage medium for the optical storage and retrieval of information, the storage medium comprising: a substrate and an active layer for retention of data. According to the invention, the active layer is provided with a pre-determined pattern (4) of bit positions (14, 14′, . . . ). Preferably, the substrate is provided with the pre-determined pattern of bit positions. The storage medium has a relatively high data density.

The invention relates to a storage medium for the optical storage and retrieval of information.

In addition, the invention relates to a method of manufacturing a storage medium for the optical storage and retrieval of information and to a record carrier having information written thereon.

The information age has led to an explosion of information available to users. (Personal) computers are omnipresent and connected via a worldwide network of computer networks. The decreasing costs of storing data, and the increasing storage capacities of the same small device footprint, have been key enablers of this revolution. While current storage needs are being met, storage technologies continue to improve in order to keep pace with the rapidly increasing demand.

Media for optical storage of the kind mentioned in the opening paragraph are well known in the art. However, both magnetic and conventional optical data storage technologies, where individual bits are stored as distinct magnetic or optical changes on the surface of a recording medium, are approaching physical limits beyond which individual bits may be too small and/or too difficult to store and/or to distinguish. Inter-pixel or inter-symbol interference is a phenomenon in which intensity at one particular pixel contaminates data at nearby pixels. Physically, this interference arises from the band-limit of the (optical) channel, originating from optical diffraction or from time-varying aberrations in the lens system.

The invention has for its object to provide a storage medium with a higher data density. According to the invention, a medium for optical storage of the kind mentioned in the opening paragraph for this purpose comprises: a substrate, an active layer for retention of data and the active layer being provided with a pre-determined pattern of bit positions.

An active layer in the present description and claims is understood to be a layer in which information can be stored (coded) and changed.

In a conventional one-dimensional (optical) storage medium a single bit row is written along a spiral. In general, the track pitch is chosen large enough to reduce thermal cross talk between neighboring tracks to acceptable levels. In addition, a recording dye layer is or, alternatively, inorganic phase change layers are distributed homogeneously across the medium.

According to the invention the active layer in the storage medium is patterned beforehand such that recording or storing (coding) information in the active layer is possible only at pre-determined positions and with a certain shape. Because the active layer is not homogeneously distributed across the medium but only present at the pre-determined bit positions, (thermal) cross talk between adjacent bit positions is significantly reduced. As a consequence, the density of the bit positions can be increased as compared to the known storage media. When retrieving information from the storage medium, the size of the bit positions can even be smaller than the spot size of the retrieval means. When information is stored (recorded) in the storage medium, the spot size of the storage means, preferably, is such that only the active layer at the desired bit position is activated or de-activated and that the adjacent bit positions are (practically) not affected by the storing means. By employing a patterned recording medium, cross-talk between bit positions is significantly reduced.

Preferably, the substrate of the storage medium is provided with the pre-determined pattern of bit positions. This has the additional advantage that the active layer is provided at the bit positions in the substrate. Patterning the substrate of the storage medium largely facilitates the manufacturing of the storage medium according to the invention.

A method of manufacturing a storage medium for the optical storage and retrieval of information comprises the following steps. As a first step, a substrate is provided with a pre-determined pattern of bit positions. Subsequently, an active layer for retention of data is provided substantially at the location of the bit positions. In a favorable embodiment of the method, a pressing tool is used to generate the predetermined pattern of bit positions. In this manner the possible bit positions are known exactly beforehand. The method of manufacturing may, additionally, provide mirror layers and thermally insulating layers.

A preferred embodiment of the storage medium according to the invention is characterized in that the pre-determined pattern comprises a two-dimensional strip of bit positions. In a conventional one-dimensional (optical) storage medium, a single bit row is written along a spiral employing bit-length encoding as encoding concept. When a pre-determined pattern comprising a two-dimensional strip of bit positions is employed, the preferred encoding concept is bit-position encoding. Preferably, a strip is aligned horizontally and consists of a number of rows and columns. Preferably, code words do not cross boundaries of a strip.

A preferred embodiment of the storage medium according to the invention is characterized in that the pre-determined pattern comprises an at least partial quasi-hexagonal or quasi-square pattern. With a quasi-hexagonal or quasi-square pattern is meant a pattern of bit positions that may be ideally arranged hexagonally or square, respectively. However, small position distortions from the ideal pattern may be present. The number of nearest neighbors is six for the hexagonal pattern whereas it is four for a square pattern. The bit error rate is smaller for the quasi-hexagonal and quasi-square pattern as compared to the known storage medium. The higher packing density of the quasi-hexagonal pattern provides a higher storing efficiency than the quasi-square pattern. The quasi-hexagonal or quasi-square patterns are very suitably employed in a storage medium comprising a two-dimensional strip of bit positions.

The storage medium according to the invention can be a record carrier having information written thereon, e.g. an optical disc, a CD, a CD-Rom, a CD-R, a CD-RW, and a DVD, BD, optical memory cards, and similar products.

Other advantageous further developments are defined in the dependent claims.

The invention will now be explained in more detail with reference to a number of embodiments and accompanying drawing figures in which:

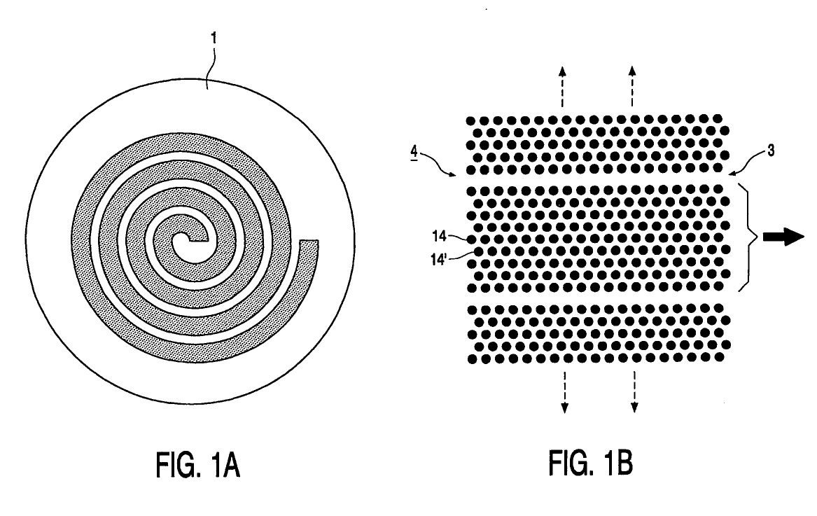

FIG. 1A shows a storing medium for optical storage and retrieval of information according to the invention;

FIG. 1B shows a detail of the storing medium of FIG. 1A;

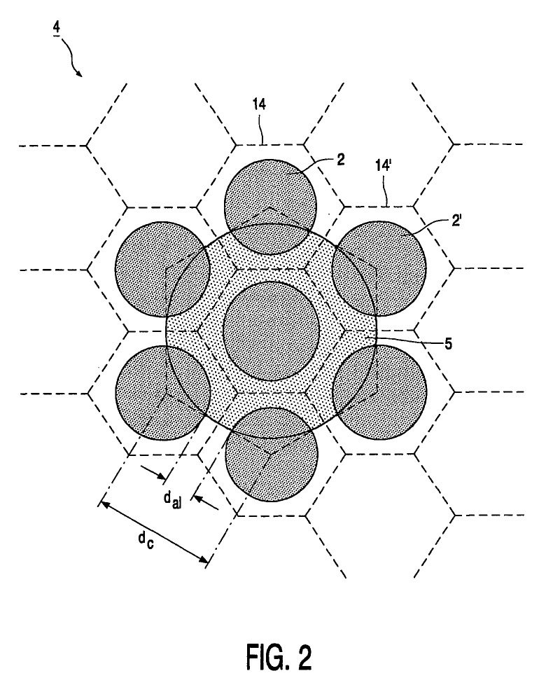

FIG. 2 shows the optical spot and bit pattern geometry of the pattern of bit positions of FIG. 1B;

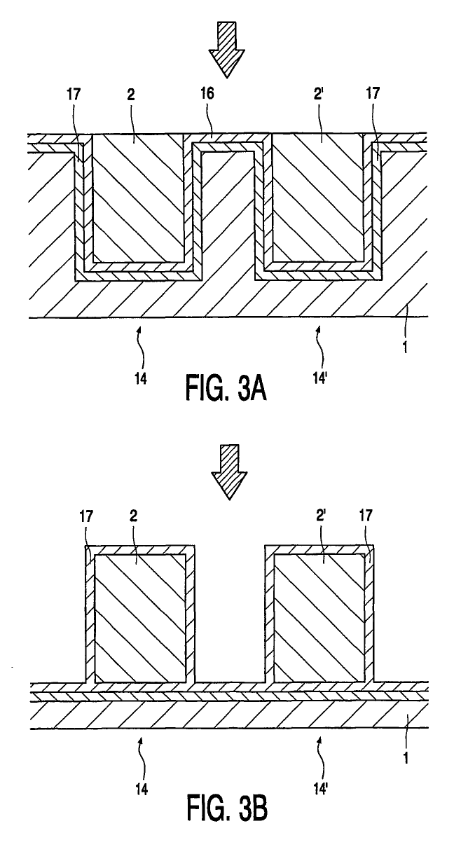

FIG. 3A shows an embodiment of the storage medium according to the invention, and

FIG. 3B shows an alternative, preferred embodiment of the storage medium according to the invention.

The Figures are purely diagrammatic and not drawn true to scale. Some dimensions are particularly strongly exaggerated for reasons of clarity. Equivalent components have been given the same reference numerals as much as possible in the Figures.

FIG. 1A shows very schematically a storing medium for optical storage and retrieval of information according to the invention. In FIG. 1A a substrate 1 is provided by a strip or track in the form of a spiral of bit positions. Upon storing and retrieving of information the spiral is followed by the storage or retrieval means, respectively. FIG. 1B shows very schematically a detail of the storing medium of FIG. 1A. A pre-determined pattern 4 of bit positions 14, 14′, . . . is shown. So-called guard bands 3 are shown between the strips or tracks of bit positions 14, 14′, . . . ; the direction in which information is stored and retrieved from a strip of bit positions 14, 14′, . . . is indicated by a bold arrow. In the example of FIG. 1B, the pattern 4 of bit positions 14, 14′, . . . is a quasi-hexagonal pattern for which the number of nearest neighbors is six. In an alternative embodiment, the pattern of bit positions is a quasi-square pattern for which the number of nearest neighbors is four. It is well known that hexagonal patterns provide the highest packing fraction. In particular, the packing fraction for the hexagonal pattern is approximately 15% higher than that of a square pattern with the same distance between nearest-neighbor bit positions. In addition, other patterns can be employed. Periodic two-dimensional patterns can be built up using triangles with arbitrary angles as basic building blocks. In addition, patterns with parallelograms and hexagons can be used.

FIG. 2 shows the optical spot and bit pattern geometry of the pattern of bit positions of FIG. 1B. Individual bit positions 14, 14′, . . . are indicated (by the dashed lines) in the pre-determined pattern 4 as well as an optical spot 5. According to the invention, an active layer 2, 2′, . . . for retention of data is provided with the pre-determined pattern 4 of bit positions 14, 14′, . . . . The active layer 2, 2′, . . . is provided only at the location of the bit positions 14, 14′, . . . . It becomes clear from the geometry of the optical spot 5 and the bit pattern that cross-talk between neighboring bits is an important issue. For retrieving information from the storage medium, cross-talk can be resolved by adequate coding and signal processing techniques. For storing information on the storage medium, for instance by employing a thermal tip writing method, cross-talk can, by way of example, be avoided by tuning (the intensity of) the optical spot 5 such that upon storing in the active layer at the central bit position the information in the active layers at the nearest neighbor bit positions is not substantially effected. An effective way to reduce the effect of cross-talk is achieved by effectively shielding the active layer 2 at a bit position 14 from the active layer 2′ at an adjacent bit position 14′.

Preferably, the[0] active layer is a recording dye layer (typical for a WORM medium). Preferably, these layers are deposited by conventional techniques such as spin coating, embossing, molding, (photo)lithography, micro-contact printing or vapor deposition. Organic dye layers can be easily patterned. Alternatively, inorganic phase change layers may also be used as re-writable medium. Preferably, the latter layers are deposited by sputtering. Patterning organic dyes is preferred as compared to patterning re-writable rare earth recording layers.

Preferably, the storage medium is provided in the substrate 1 beforehand such that storing information is possible only at the pre-determined position and with a pre-determined shape. In this manner, a storage medium with a relatively high data density is obtained. Preferably, a pressing tool is employed to generate the pre-determined pattern 4 of bit positions 14, 14′, . . . . In this manner the possible bit positions are known exactly beforehand. The pressing tool imprints the pre-determined bit position structure as shown in FIG. 1B in the form of a spiral as shown in FIG. 1A in a single print step. The pattern of bit positions 4 is embossed in the pressing tool.

Preferably, the scaled distance d_{c}* between centers of the bit positions 14, 14′, . . . is less than 0.84, preferably less than 0.63. The scaled distance d_{c}* is a dimensionless distance. The distance d_{c} (see FIG. 2) is scaled to the effective optical resolution of the system, i.e.
d_{c}*=d_{c}/(λ/2NA).
The expression λ/2NA is the so-called MTF cut-off, λ being the wavelength of (laser) light in nm and NA being the numerical aperture of the system. En this manner, d_{c}* is independent from the nature of the readout system. If a system with a blue laser (λ=405 nm) and a NA=0.85 is used, d_{c} is, preferably, less than 200 nm, preferably less than 150 nm.

Similarly, the scaled distance dₐ₁* between the active layer at a first bit position and the active layer at an adjacent bit position is less than 0.42, preferably less than 0.3. The scaled distance dₐ₁* is a dimensionless distance. The distance dₐ₁ (see FIG. 2) is scaled to the effective optical resolution of the system, i.e.
dₐ₁*=dₐ₁/(λ/2NA).
If a system with a blue laser (λ=405 nm) and a NA=0.85 is used, dₐ₁ is, preferably, less than 100 nm, preferably less than 70 nm. From experiments, it was found that a very suitable values for d_{c}*≈0.59 and dₐ₁*≈0.17. For a system with a blue laser and a NA=0.85 the corresponding distances are d_{c}≈140 nm and dₐ₁≈40 nm. The result is a significantly higher bit density for the storage medium according to the invention as compared to the known storage media. Compared to the so-called Blu-ray Disc standard, the physical bit density is increased roughly by a factor or two. By employing a recording medium with pre-determined pattern of bit positions provided with an active layer, writing cross-talk between bit positions is significantly reduced.

When a pre-determined pattern comprising a two-dimensional strip of bit positions as shown in FIGS. 1A, 1B and 2 is employed, the preferred encoding concept is bit-position encoding. Reliable readout at such a high packing density of the information bits is only possible by the synchronized detection and processing of signals from several bit-rows. This can e.g. be done by using an array of light spots that simultaneously detects (or writes) the two-dimensional (2D) encoded information, thereby dramatically increasing the data rate. Using the obtained 2D signal information, the large signal energy present in inter-symbol interference (which in standard optical recording largely is considered as part of the noise) can be coherently used in the reconstruction of the original 2D bit patterns. So-called two-dimensional coding enhances the speed of data coding and decoding. The location of the active layer at the pre-determined bit positions is known to a high accuracy beforehand.

FIG. 3A shows very schematically an embodiment of the storage medium according to the invention. In the situation of FIG. 3A, the dye forming the active layer 2, 2′ is confined to pits forming the bit positions 14, 14′ provided in the substrate 1. The light incident side is indicated by a large arrow. In the example of FIG. 3A a mirror layer 16 has been provided to increase the reflectivity. In a favorable embodiment, this mirror layer 16 is made from aluminum or silver. In addition, a thermally insulating layer 17 to reduce cross-talk by heat diffusion between the pits is provided in FIG. 3A. An example of a thermally insulating layer 17 is a dielectric with a low thermal conductivity. In alternative embodiments, dielectric layers (not shown in FIG. 3A) are provided to optimize the reflection/absorption properties of the stack. Such dielectric layers can be partly the same as the thermally insulation layer or can be deposited on top of the dye.

The sequence of thermal capping and mirror layers can be reversed. This improves the thermal insulation, but puts more stringent demands on the thermal shield layer with regard to its optical properties. In the embodiment of FIG. 3A, the light does not reach the thermal capping layer and does not have to be transparent, free of birefringence, etc. In the embodiment where the mirror layer lies underneath the capping layer, the properties of the capping layer influence the optical properties of the design (interference stack).

FIG. 3B shows very schematically an alternative, preferred embodiment of the storage medium according to the invention. In the situation of FIG. 3B, the dye forming the active layer 2, 2′ protrudes from the bit positions 14, 14′ on the substrate 1. The light incident side is indicated by a large arrow. In the example of FIG. 3B a mirror layer 16 has been provided to increase the reflectivity. In addition, a thermally insulating layer 17 to reduce cross-talk by heat diffusion between the pits is provided in FIG. 3B. In the example of FIG. 3B, an additional capping layer is provide between the active layer 2, 2′ and mirror layer 16 to further isolate the dye from its surroundings. The embodiment of FIG. 3B has the advantage that the light can couple more efficiently into the dye “pillars” without having to couple into the small waveguide structure of a pit like the ones in FIG. 3A. In the situation of FIG. 3B heating is more efficient.

An additional advantage of the embodiment of FIG. 3B is that the bits are better isolated thermally from each other as the (metal) mirror layer 16 lies only at the bottom of the pits adjacent to the dye. The structure of FIG. 3B can be used to enhance/tune the reflection/absorption properties of the recording stack.

A method of manufacturing the stack shown in FIG. 3B starts with depositing the (optional) mirror layer 16, the (optional) thermal capping layer 17, and the optional dielectric layers (not shown in FIG. 3B) are deposited onto the substrate 1. As a next step, the dye (active layer) is selectively transferred onto the mirror layer by e.g. wet embossing, micro-contact printing and wetting/non-wetting technologies. As a final step, the (optional) thermal capping layer 17 and/or dielectric layers (not shown in FIG. 3B) are deposited onto the structure, resulting in the stack of FIG. 3B.

An alternative method of manufacturing the stack shown in FIG. 3B starts with depositing the (optional) mirror layer 16, the (optional) thermal capping layer 17, and the optional dielectric layers (not shown in FIG. 3B) onto the substrate 1. As a next step, the structure is imprinted into the light incident (cover) layer. Next, the (optional) thermal capping and/or dielectric layers (not shown in FIG. 3B) are deposited onto the structure. Subsequently, the dye (active layer) is deposited onto the light incident layer. As a final step, the light incident layer is glued onto the substrate, resulting in the stack of FIG. 3B.

The land-pit contrast in the deposited dye thickness should be as large as possible, which is different from standard recording where the dye is deposited more or less homogeneously on and between the grooves. The patterned medium introduces one new factor into the recording system. In the (standard) case of a homogeneously recording layer, the data structure of the optical properties of the recording medium are selectively introduced during recording. Thereby, a large optical contrast between recorded an unrecorded areas can be easily achieved. In the pre-patterned case, care has to be taken to also achieve the required contrast between written and non-written bits. This can be done, e.g. by using a recording material that is largely transparent in its unwritten state such that the effective reflectivity of the stack is largely determined by the (homogenous) metal layer. Upon writing, the optical properties of the recording material are changed such that the effective reflectivity of the medium is now to a large extend determined by the active medium's properties.

The scope of the invention is not limited to the embodiments. The invention is embodied in each new characteristic and each combination of characteristics. Any reference sign do not limit the scope of the claims. The word “comprising” does not exclude the presence of other elements or steps than those listed in a claim. Use of the word “a” or “an” preceding an element does not exclude the presence of a plurality of such elements.

1. A storage medium for the optical storage and retrieval of information, the storage medium comprising:
a substrate (1),
an active layer (2, 2′, . . . ) for retention of data,
the active layer (2, 2′, . . . ) being provided with a predetermined pattern (4) of bit positions (14, 14′, . . . ),
the substrate (1) being provided with the pre-determined pattern (4) of bit positions (14, 14′, . . . ) for reducing cross talk between adjacent bit positions.

2. A storage medium as claimed in claim 1, characterized in that the pre-determined pattern (4) comprises a two-dimensional strip of bit positions (14, 14′, . . . ).

3. A storage medium as claimed in claim 1 or 2, characterized in that the pre-determined pattern (4) comprises an at least partial quasi-hexagonal or quasi-square pattern.

4. A storage medium as claimed in claim 1 or 2, characterized in that the scaled distance d_{c}* between centers of the bit positions 14, 14′, . . . is less than 0.84, preferably less than 0.63.

5. A storage medium as claimed in claim 1 or 2, characterized in that the scaled distance dₐ₁* between the active layer at a first bit position and the active layer at an adjacent bit position is less than 0.42, preferably less than 0.3.

6. A method of manufacturing a storage medium for the optical storage and retrieval of information, the method comprising the following steps:
a substrate (1) is provided with a pre-determined pattern (4) of bit positions (14, 14′, . . . ),
an active layer (2, 2′, . . . ) for retention of data is provided substantially at the location of the bit positions (14, 14′, . . . ),
a two-dimensional strip of bit positions (14, 14′, . . . ) in the form of a spiral being provided on the substrate.

7. A method of manufacturing a storage medium as claimed in claim 6, characterized in that a pressing tool is employed to generate the pre-determined pattern (4) of bit positions (14, 14′, . . . ).

8. A method of manufacturing a storage medium as claimed in claim 6 or 7, further comprising the step of providing a mirror layer (16) between the substrate and the active layer.

9. A method of manufacturing a storage medium as claimed in claim 6 or 7, further comprising the step of providing a thermally insulating layer (17) between the active layer (2, 2′, . . . ) at a first bit position ( ) and the active layer at an adjacent bit position ( ).

10. A record carrier having information written thereon, characterized in that the information is coded in an active layer (2, 2′, . . . ) provided by a method of manufacturing as claimed in claim 6 or 7.

11. A record carrier as claimed in claim 10, characterized in that the record carrier is an optical disc.
